(19) United States
(12) Patent Application Publication
(10) Pub. No.: US 2016/0174267 A1
(43) Pub. Date: Jun. 16, 2016

(54) PROPRIETARY PACKET EXCHANGE FOR ENHANCED NFC COMMUNICATION

(71) Applicant: QUALCOMM Incorporated, San Diego, CA (US)

(72) Inventors: Mahbod MOFIDI, San Diego, CA (US); Ashish BANTHIA, San Diego, CA (US)

(21) Appl. No.: 14/641,063

(22) Filed: Mar. 6, 2015

Related U.S. Application Data
(60) Provisional application No. 62/092,011, filed on Dec. 15, 2014.

(51) Int. Cl. H04W 76/02; H04B 5/00; H04B 5/02

(52) U.S. Cl. CPC H04W 76/02; H04B 5/02; H04B 5/0031

(57) ABSTRACT

Various aspects are described herein in connection with methods and/or apparatuses of near-field communication. For example, various methods and apparatuses include an NFC transmitter configured to send a communication establishment (CES) command. The CES command includes at least one transmitter communication enhancement (TX CEN) parameter comprising an operation setting based on a geographic location of the NFC transmitter. The NFC transmitter is configured to determine whether a CES response was received from an NFC receiver and adjust a communications channel based on at least one receiver (RX) CEN parameter included in the CES response based on the at least one TX CEN parameter. Various methods and apparatuses also include a NFC receiver configured to receive a CES command from an NFC transmitter and send a CES response. The CES response includes at least one RX CEN parameter comprising an operation setting based on a geographic location of the NFC receiver.

### CROSS-REFERENCE TO RELATED APPLICATIONS

This application claims the benefit of U.S. Provisional Application Ser. No. 62/092,011, entitled, “Proprietary Packet Exchange for Enhanced NFC Communication” and filed on Dec. 15, 2014, which is expressly incorporated by reference herein in its entirety.

### BACKGROUND

The disclosed aspects relate generally to communications between and/or within devices and specifically to improving near-field communication mode signaling.

Advances in technology have resulted in smaller and more powerful personal computing devices. For example, there currently exist uses of a variety of portable personal computing devices, including wireless computing devices such as portable wireless telephones, personal digital assistants (PDAs), and paging devices that each small, lightweight, and can easily be carried by users. More specifically, the portable wireless telephones, for example, further include cellular telephones that communicate voice and data packets over wireless networks. Many such cellular telephones are manufactured with ever-increasing computing capabilities, and as such, are becoming tantamount to small personal computers and hand-held PDAs. Further, such devices are enabling communications using a variety of frequencies and applicable coverage areas, such as cellular communications, wireless local-area network (WLAN) communications, near-field communication (NFC), etc.

During communication between two NFC devices, various issues related to the radio frequency (RF) can occur that directly affect operability. For example, changes in the operating volume (OV), overload due to the size and shape of NFC antennas, and assumptions made in implementation of NFC devices can greatly affect interoperability. However, specifications for NFC do not disclose ways to adjust the communications channel based on configurations of the NFC devices in operation. Thus, improvements for interoperability of NFC devices may be desired.

### SUMMARY

The following presents a summary of one or more aspects to provide a basic understanding of such aspects. This summary is not extensive overview of all contemplative aspects, and is not intended to identify key or critical elements of all aspects nor delineate the scope of any or all aspects. Its purpose is present some concepts of one or more aspects form as a prelude to the more detailed description presented later.

Various aspects are described in connection with exchanging messages for enhanced communications between NFC devices.

For example, in an aspect, methods include a NFC transmitter sending a communication establishment (CES) command, wherein the CES command includes at least one transmitter communication enhancement (TX CEN) parameter comprising an operation setting based on a geographic location of the NFC transmitter. Methods also include the NFC transmitter determining whether a CES response was received from a NFC receiver and the NFC transmitter adjusting a communications channel based on at least one receiver (RX) CEN parameter included in the CES response based on the at least one TX CEN parameter.

In an aspect, methods include a NFC receiver receiving a CES command from a NFC transmitter, wherein the CES command includes at least one TX CEN parameter. Methods also include the NFC receiver sending a CES response comprising at least one RX CEN parameter comprising an operation setting based on a geographic location of the NFC receiver, wherein the establishment of a communications channel is adjusted by the NFC transmitter based on at the at least one RX CEN parameter included in the CES response.

In an aspect, apparatuses include a NFC transmitter configured to send a CES command, wherein the CES command includes at least one TX CEN parameter comprising an operation setting based on a geographic location of the NFC transmitter. The NFC transmitter is also configured to determine whether a CES response was received from a NFC receiver and the NFC transmitter adjusting a communications channel based on at least one RX CEN parameter included in the CES response based on the at least one TX CEN parameter.

In an aspect, apparatuses include a NFC receiver configured to receive a CES command from a NFC transmitter, wherein the CES command includes at least one TX CEN parameter. The NFC receiver is also configured to send a CES response comprising at least one RX CEN parameter comprising an operation setting based on a geographic location of the NFC receiver, wherein the establishment of a communications channel is adjusted by the NFC transmitter based on at the at least one RX CEN parameter included in the CES response.

In an aspect, apparatuses for enhanced communications between NFC devices are provided. The apparatuses include means for sending a CES command, wherein the CES command includes at least one TX CEN parameter comprising an operation setting based on a geographic location of the NFC transmitter. Apparatuses also include means for determining whether a CES response was received from a NFC receiver and means for adjusting a communications channel based on at least one RX CEN parameter included in the CES response based on the at least one TX CEN parameter.

In an aspect, methods and apparatuses for enhanced communications between NFC devices are provided. The apparatuses include means for receiving a CES command from a NFC transmitter, wherein the CES command includes at least one TX CEN parameter. Apparatuses also include means for sending a CES response comprising at least one RX CEN parameter comprising an operation setting based on a geographic location of the NFC receiver, wherein the establishment of a communications channel is adjusted by the NFC transmitter based on at the at least one RX CEN parameter included in the CES response.

In an aspect, a non-transitory computer-readable medium storing computer-executable code for enhanced communications between NFC devices is provided. For example, the computer-readable medium includes code for sending a CES command, wherein the CES command includes at least one TX CEN parameter comprising an operation setting based on a geographic location of the NFC transmitter. The computer-readable medium also includes code for determining whether a CES response was received from a NFC receiver and the NFC transmitter and code for adjusting a communications channel based on at least one RX CEN parameter included in the CES response based on the at least one TX CEN parameter.

In an aspect, a non-transitory computer-readable medium storing computer-executable code for enhanced communications between NFC devices is provided. For example, the computer-readable medium includes code for receiving a CES command from a NFC transmitter, wherein the CES command includes at least one TX CEN parameter. The computer-readable medium also includes code for sending a CES response comprising at least one RX CEN parameter comprising an operation setting based on a geographic location of the NFC receiver, wherein the establishment of a communications channel is adjusted by the NFC transmitter based on at the at least one RX CEN parameter included in the CES response.

In an aspect, the CEN parameter includes at least one of a strength of a carrier field of the NFC transmitter or a load modulation preference of the NFC transmitter or NFC receiver.

To accomplish the forthcoming and related ends, the one or more aspects comprise features hereinafter fully described and particularly pointed out in the claims. The following description and the annexed drawings set forth detail certain illustrated features of the one or more aspects. These features are indicative, however, of but a few of the various ways in which the principles of various aspects may be employed, and this description is intended to include all such aspects of their equivalents.

### BRIEF DESCRIPTION OF THE DRAWINGS

The disclosed aspects will hereinafter be described in conjunction with the appended drawings, provided to illustrate and not to limit the disclose aspects, wherein like destinations denote like elements, and in which:

FIG. 1 is a block diagram of a wireless communication system in accordance with an aspect of the present disclosure;

FIG. 2 is a schematic diagram of a wireless communication system in accordance with an aspect of the present disclosure;

FIG. 3 is a block diagram of an NFC environment in accordance with an aspect of the present disclosure;

FIG. 4 is a block diagram of another NFC environment in accordance with an aspect of the present disclosure; and

FIG. 5 is a signaling diagram describing transfers of message between devices and device components in accordance with an aspect of the present disclosure;

FIG. 6 is a flowchart describing an aspect of the present disclosure;

FIG. 7 is a flowchart describing another aspect of the present disclosure; and

FIG. 8 is a functional block diagram example architecture of a communications device in accordance with an aspect of the present disclosure.

Additionally, an attached Appendix includes additional figures and description that form a part of the present disclosure.

### DETAILED DESCRIPTION

Various aspects are now described with reference to the drawings. In the following description, for purposes of explanation, numerous specific details are set forth to provide a thorough understanding of one or more aspects. It should be understood, however, that such aspect(s) may be practice without these specific details.

The present aspects generally relate to managing a communications channel established for near-field communications between an NFC transmitter device and an NFC receiver device. Specifically, the present aspects provide a way of managing and adjusting a communications channel based on communication-related parameters that define capabilities and/or operational settings of the NFC transmitter and/or NFC transceiver. For example, the NFC transmitter can send a customized, transmitter (TX) communications establishment (CES) message to the NFC receiver. The TX CES message can include one or more RF parameters related to preferences of the NFC transmitter when establishing a communications channel with a target NFC device, e.g., the NFC receiver in this case. When a capable NFC receiver receives the TX CES message, the capable NFC receiver can send back to the NFC transmitter a customized, receiver (RX) CES message that includes one or more RF parameters related to preferences or limits of the NFC receiver to operate using a communications channel established by the NFC transmitter. In an aspect, the NFC receiver can transition to an idle state after sending the RX CES message. The NFC transmitter, upon receiving the RX CES message, can either establish or adjust a communications channel with the NFC receiver based on its own RF parameters and the RF parameters received in the RX CES message. As such, both the NFC transmitter and the NFC receiver may experience an improved communication environment by operating the established communication channel according to one or more indicated communication-related parameters.

In an aspect, for example, the TX/RX CES messages can include RF parameters, such as but not limited to one or more of: an operation setting based on a geographic location of the NFC transmitter/receiver, carrier field strength of the NFC transmitter, or a load modulation preference (e.g., positive or negative load modulation) of the NFC transmitter/receiver. The geographic location parameter of the NFC device can identify, for example, the geographic location of the NFC receiver, the type of device that received the message (e.g., an identifier), and or a specified location, such as a specific public transportation station or intersection within a city.

In an aspect, the TX and/or RX CES message can be a packet that includes one or more of the parameters as values (e.g., respective 1-byte values) that can be loaded from the memory of the respective NFC device. In an aspect, for instance, some of the RF parameters can be updated based on the exchange and the NFC transmitter can readjust the communications channel based on the updated value(s) of the one or more updated RF parameters.

Aspects of the present disclosure are depicted with reference to one or more components and one or more methods that may perform the actions or functions described herein. In an aspect, the term “component” as used herein may be one of the parts that make up a system, may be hardware or software or some combination thereof, and may be divided into other components. Although the operations described herein are presently particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

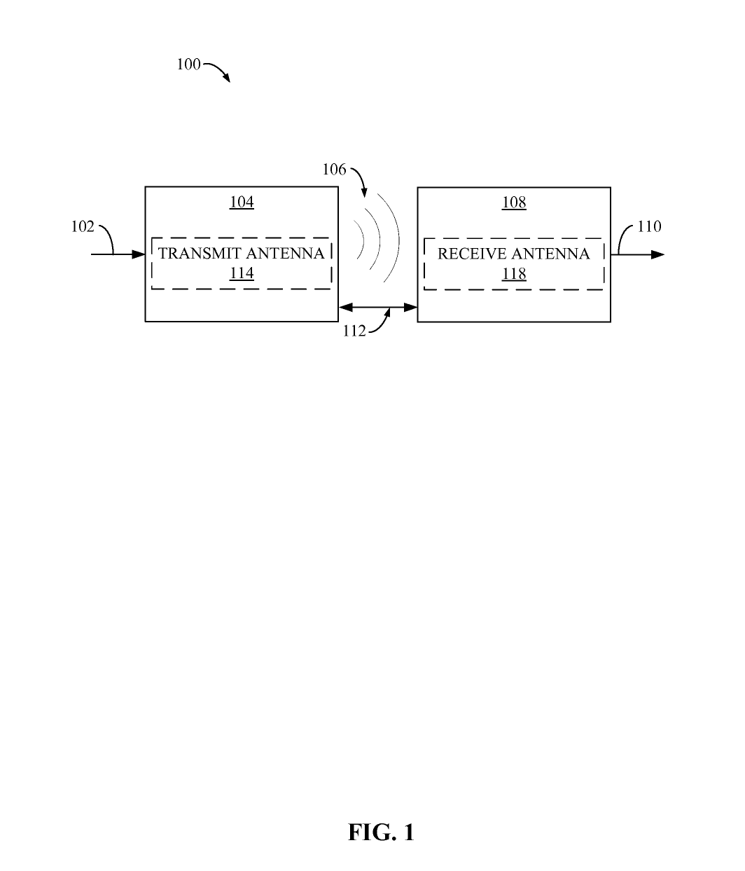

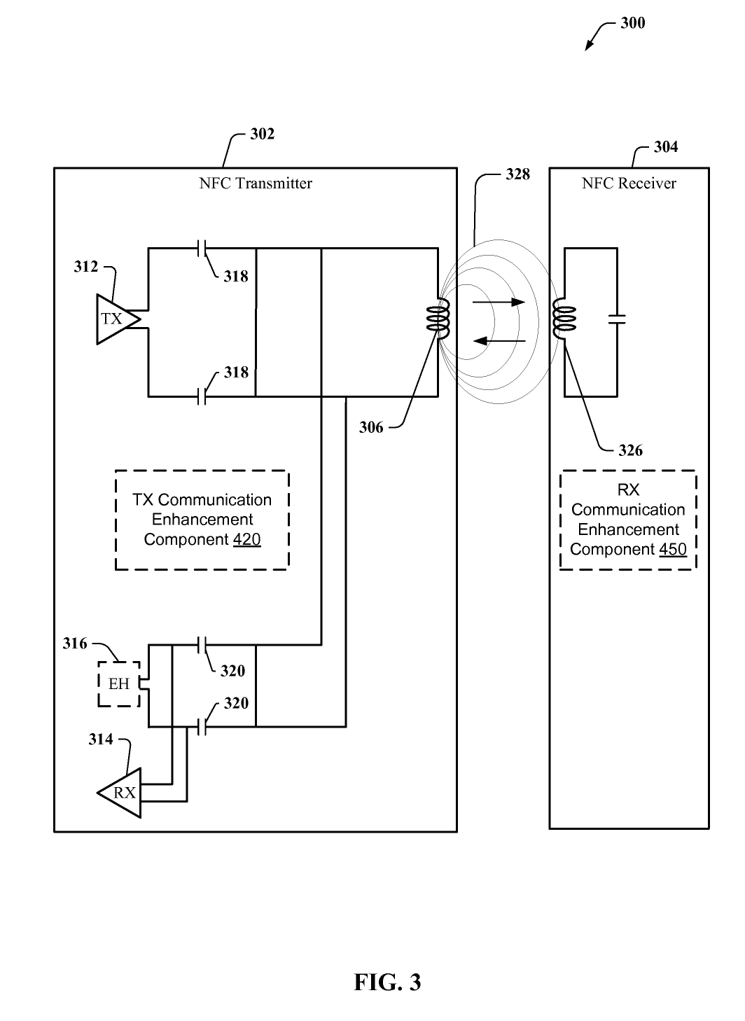

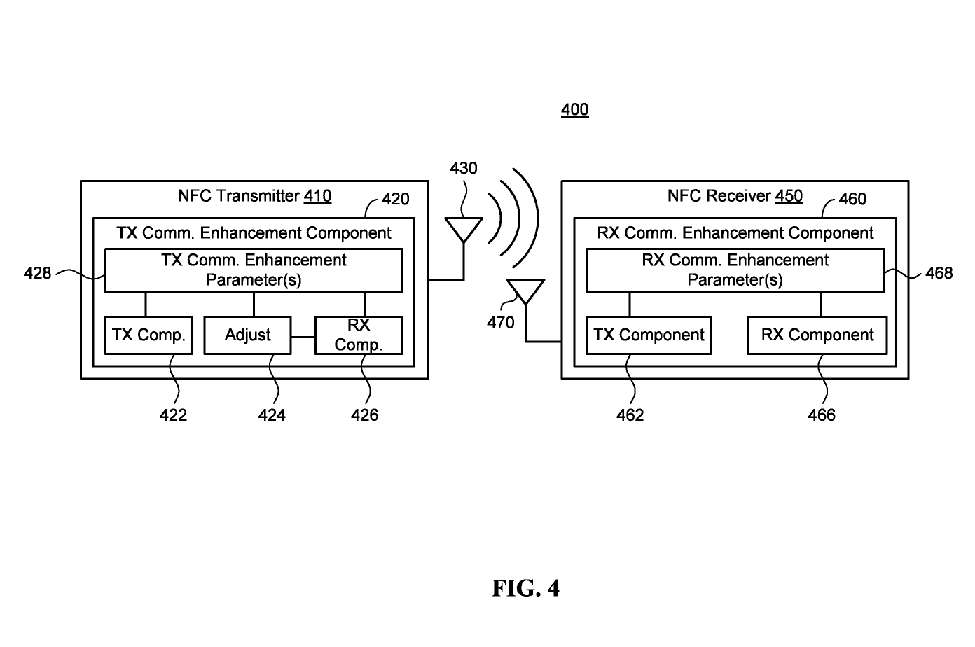

FIG. 1 illustrates a wireless transmission or charging system 100, which may implement one or more of the various aspects described herein with respect to FIGS. 3-8 for establishment of an enhanced communication channel between NFC devices. In some aspects, transmitter 104 or receiver 108 can be included as part of NFC transmitter 302 or 410 and/or NFC receiver 304 or 450 (see e.g., FIGS. 3 and 4). In other aspects, for example, transmitter 104 or receiver 108 can be the same as or similar to transmitter component 312 or receiver component 314 and can form or otherwise be part of a transceiver included in NFC transmitter 302 and/or NFC receiver 304. Additionally, transmit antenna 114 or receive antenna 118 can form or otherwise be part of antenna coil 306 or 326 (FIG. 3).

Input power 102 is provided to a transmitter 104 for generating a radiated inductive field 106 for providing energy transfer. Receiver 108 couples to the radiated inductive field 106 and generates output power 110 for storage or consumption by a device coupled to output power 110. Both transmitter 104 and receiver 108 are separated by a distance 112, which is also referred to herein as an operating volume (OV). In one example, transmitter 104 and receiver 108 are configured according to a mutual, resonant relationship and when the resonant frequency of receiver 108 and the resonant frequency of transmitter 104 are within a threshold OV, transmission losses between transmitter 104 and receiver 108 are minimal (e.g., when receiver 108 is located in the “near-field” of the radiated inductive field 106). As will be discussed further in relation to FIG. 4, the resonant frequency of receiver 108 and the resonant frequency of transmitter 104 may not be consistent (e.g., coupling factor (k-factor) variations throughout the OV) or may be modified due to orientation of transmit antenna 114 and/or receive antenna 118. This may cause interoperatibility issues, as transmission losses between transmitter 104 and receiver 108 may rise.

Transmitter 104 can include a transmit antenna 114 for transmitting energy and signals. Receiver 108 includes a receive antenna 118 for receiving signals and energy, if needed. Transmit antenna 114 and receive antenna 118 can be sized according to applications and devices associated therewith. As stated, and efficient energy transfer can occur by coupling a large portion of the energy in the near field of transmitting antenna 114 to receive antenna 118 rather than propagating most of the energy an electromagnetic wave to a far field. When in this near field, a coupling mode may be developed between transmit antenna 114 and receive antenna 118. The area around antennas 114 and 118 where this near-field coupling may occur is referred to herein as a coupling-mode region.

In some configurations, where transmitter 104 and receiver 108 are in very close proximity, matching networks related to antennas 114, 118 that process the signals may become detuned due to high mutual coupling in signals communicated between transmitter 104 and receiver 108, thus communications between transmitter 104 and receiver 108 may break down. This condition is referred to herein as over-coupling. In such examples, as described further herein, transmitter 104 can detect such over-coupling with receiver 108 or related receive antenna 118 and can attempt to mitigate the condition by modifying one or more transmit and/or receive parameters at transmitter 104. In an aspect, transmitter 104 can receive the receive parameters from receiver 108 in a customized message (e.g., a RX CES message) that includes one or more receive parameters (e.g., RX CES parameters) and adjust the communications channel.

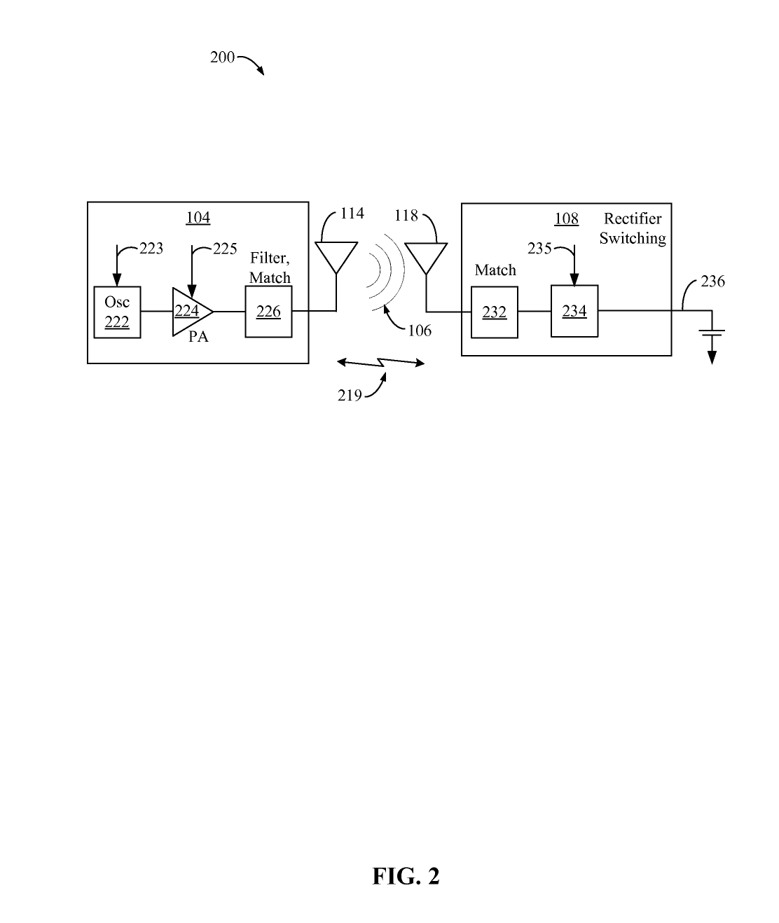

FIG. 2 is a schematic diagram of an example near-field wireless communication system 200, which may implement one or more of the various aspects described herein with respect to FIGS. 3-8 for establishment of an enhanced communication channel between NFC devices. Transmitter 104 includes an oscillator 222, a power amplifier 224 and a filter-and-matching circuit 226. In some aspects, transmitter 104 may be included as part of NFC transmitter 302 (FIG. 3). Specifically, for example, transmitter 104 or receiver 108 can be similar to transmitter component 312 or receiver component 314 and can form or otherwise be part of a transceiver included in NFC transmitter 302 and/or NFC receiver 304. Additionally, transmit antenna 114 or receive antenna 118 may form or otherwise be part of antenna coil 306 or 326 (FIG. 3). Oscillator 222 is configured to generate a signal at a desired frequency, which may be adjusted in response to adjustment signal 223. The oscillator signal may be amplified by power amplifier 224 with an amplification amount responsive to control signal 225. Filter-and-matching circuit 226 may be included to filter out harmonics or other unwanted frequencies and match the impedance of transmitter 104 to transmit antenna 114.

Receiver 108 may include a matching circuit 232 and a rectifier-and-switching circuit 234 to generate a DC-power output to charge a battery 236 (as shown in FIG. 2) or power a device coupled to the receiver, though it is to be appreciated that devices may each have batteries (e.g., in peer-to-peer communications) such that powering by magnetic field may not be needed. Matching circuit 232 may be included to match the impedance of receiver 108 to receive antenna 118. Receiver 108 and transmitter 104 make communicate on a separate communications channel 219 (e.g., Bluetooth, Wi-Fi, zigbee, cellular, etc.) in one example.

With reference to FIG. 3, communication network 300 may include an aspect of an NFC transmitter 302 and an NFC receiver 304 configured to establish an enhanced NFC communication channel according to one or more aspects described herein. NFC transmitter 302 can include an NFC antenna coil 306 configured to facilitate NFC communications with NFC receiver 304, which may have a similar NFC coil 326. NFC transmitter 302 may be the same or similar to transmitter 104, while NFC receiver 304 may be the same or similar to NFC receiver 108. As will be discussed in further detail in FIG. 4, NFC transmitter 302 can include a transmitter communication enhancement component 420, while NFC receiver 304 can include a receiver communication enhancement component 460, which may cooperatively communicate to exchange one or more parameters to enable establishment of an enhanced NFC communication channel according to one or more aspects described herein.

As part of NFC communications, NFC antenna coil 306 may generate an electromagnetic field in the area around NFC antenna coil 306. The strength of the field may depend on the power source and the size and number of turns in NFC antenna coil 306. Further, impedance mismatches may cause a range of amplitude/phase changes dependent on size and inductance of NFC antenna coil 306 in magnetic field 328. Capacitor 318 may be connected in parallel with the NFC antenna coil 306, where a transmitter component 312 and capacitors 318 may form an RLC oscillator, establishing a resonant circuit with a frequency that corresponds to one or more transmission frequencies of NFC transmitter 302.

Because of the wavelength of the frequency used is several times greater than the close-proximity distance between NFC antenna coil 306 and NFC antenna coil 326 of NFC receiver 304, the electromagnetic field can be treated as an alternating magnetic field 328. This region of close proximity is referred to as the near-field region. NFC transmitter 302 and NFC receiver 304 may be linked by their mutual inductance, as in an air-core transformer, with the primary coil being the NFC antenna coil 306 and the secondary coil being antenna coil 326 of NFC receiver 304. Alternating magnetic field 328 penetrates antenna coil 326 of NFC receiver 304 when it is in the near-field region, inducing an alternating current in antenna coil 326 of NFC receiver 304.

When operating in a listening mode, NFC antenna coil 306, capacitors 320, optional energy harvester (EH) 316, and receiver component 314 may form an RLC oscillator, establishing a resonant circuit, over which modulation of signals by NFC receiver 304 can be detected. When operating in a transmitting mode, NFC transmitter 302 may apply a variable-load resistance to NFC antenna coil 306, thereby modulating magnetic field 328, to send a transmitted signal to transfer data to NFC receiver 304.

As part of NFC communications, NFC antenna coil 306 may generate an electromagnetic field in the area around NFC antenna coil 306. The strength of the field may depend on the power source and the size and number of turns in NFC antenna coil 306. Further, impedance mismatches may cause a range of amplitude/phase changes dependent on the size and inductance of NFC antenna coil 306 in magnetic field 328. Capacitor 318 may be connected in parallel with NFC antenna coil 306, where transmitter component 312 and capacitors 318 may form and RLC oscillator, establishing a resonant circuit with a frequency that corresponds to one or more transmission frequencies of NFC transmitter 302.

Referring to FIG. 4, in an aspect, communication network 400 may include an NFC transmitter 410 and an NFC receiver 450, both of which may be configured to establish an enhanced NFC communication channel according to one or more aspects described herein. NFC transmitter 410 can include an antenna 430, which can be the same or similar to transmit antenna 114 and/or antenna coil 306 and may be configured to facilitate communication with NFC receiver 450 using NFC. Similarly, NFC receiver 450 can include an antenna 470, which can be the same or similar to receive antenna 118 and/or antenna coil 326 and may be configured to enable communication with NFC transmitter 410 using NFC.

For example, NFC receiver 450 may correspond to a device, card, or tag, connected wirelessly over the NFC radio interface to NFC transmitter 410. As a result, NFC transmitter 410 may, in some non-limiting examples presented in the present application, be referred to as a requesting or initiator device. NFC receiver 450 can communicate with NFC transmitter 410 through implementation of one or more NFC-based technologies (e.g., NFC-A, NFC-B, NFC-F, etc.). In some aspects, NFC transmitter 410 and/or NFC receiver 450 may be operable to communicate via an NFC module that includes one or more RF interfaces communicating based on one or more RF protocols in either an active or passive communication mode. In an aspect, NFC receiver 450 can be configured to be connected to an access network and/or core network (e.g., a CDMA network, a GPRS network, a UMTS network, and/or other types of wired or wireless communication networks). In some aspects, NFC transmitter 410 can include, but is not limited to, a reader/writer device, a peer initiator device, a remote peer target device, etc.

In a further aspect, NFC transmitter 410 may generate and transmit one or more communication establishment (CES) commands, which, in a non-limiting aspect, may query NFC receiver 450 for, or otherwise request, RF parameter information or other information (e.g., receiver communication enhancement (RX CEN) parameters 468) corresponding to establishment and/or enhancement of a communications channel. Furthermore, in an aspect, the communication establishment (CES) command may contain one or more RF parameters (e.g., transmission communication enhancement (TX CEN) parameters 428) associated with the communication with NFC transmitter 410. These RX CEN parameters 468 and TX CEN parameters 428 can include, for example, one or more of: the resonant frequency of NFC transmitter 410 or NFC receiver 450, the carrier field strength produced by NFC transmitter 410, the maximum power level of signals transmitted (e.g., maximum power control step) by NFC transmitter 410 or by NFC receiver 450, geographic location, country, location in which NFC transmitter 410 or NFC receiver 450 is located, identification (ID) of the specific NFC transmitter 410 or NFC receiver 450, and/or the preference of NFC transmitter 410 for positive or negative (e.g., active or passive) load modulation or the load modulation type (e.g., positive or negative) of the NFC receiver 450. Examples of TX and RX CEN parameters 428 and 468 are listed below in Tables 1 and 2 for a 7-byte proprietary packet.

TABLE 1
Byte 0: Command Code. Identifies this packet as a Proprietary Packet.
Byte 1: Initiator resonant frequency
Byte 2: Initiator field strength
Byte 3: Max power control step (0 to 10)
Byte 4: Region/Country
Byte 5: Positive or negative load modulation preference
Byte 6: CRC_A

TABLE 2
Byte 0: Command Code. Identifies this packet as a Proprietary Packet.
Byte 1: Target resonant frequency
Byte 2: Reserved
Byte 3: Max power control step (0 to 10)
Byte 4: Region/Country
Byte 5: Positive or negative load modulation transmitted
Byte 6: CRC_A

Transmission (TX) communication enhancement (CEN) component 420 can include a TX component 422 for sending signals/messages to NFC receiver 450, an adjustment component 424 for adjusting one or more parameters for establishing or maintaining a communication channel with NFC receiver 450, a reception (RX) component 426 for receiving signals/messaging from NFC receiver 450, and one or more TX CEN parameters 428 that define preferences, limits, or settings relating to establishing or maintaining a communication channel with NFC receiver 450. TX CEN component 420 can be configured to use one or more of TX CEN parameters 428 and/or RX CEN parameters 468 to establish and adjust a communications channel between NFC transmitter 410 and NFC receiver 450 that enhances interoperability by accounting for configurations or changes to one or more RF parameters that affect the quality of the communications channel.

More specifically, for example, TX component 422 can be configured to send one or more messages via antenna 430 to NFC receiver 450. In an aspect, for instance, TX component 422 can retrieve one or more of the TX CEN parameters 428 and include them in a message (e.g., a communication establishment command) and send the message to NFC receiver 450. Further, for example, RX component 426 can be configured to receive one or more messages via antenna 430 from NFC receiver 450. In an aspect, for instance, RX component 426 can receive a message (e.g., a communication establishment response) from NFC receiver 450 and retrieve one or more of the RX CEN parameters 468 included in the message.

Also, in an aspect, adjustment component 424 can be configured to establish and/or adjust the characteristics of a communication channel between NFC transmitter 410 and NFC receiver 450. In an aspect, for instance, adjustment component can receive one or more TX CEN parameters 428 and/or RX CEN parameters 468 via RX component 426 and establish and/or adjust one or more characteristics of the communication channel based on the received parameters.

In some aspects, adjustment component 424 can prioritize parameters such that some parameters have precedence over other parameters. For example, adjustment component 424 can receive a load modulation preference parameter from TX CEN parameters 428 and a load modulation transmission type parameter from RX CEN parameters 468. Adjustment component 424 can configure the communication channel based on the load modulation transmission type parameter, overwriting the load modulation preference parameter if necessary. In some aspects, adjustment component 424 can receive updated ones of parameters 428 or 468 after the communication channel is established. In such instances, adjustment component 424 can adjust the communication channel based on the updated parameters.

Transmitter communication enhancement (TX CEN) parameters 428 can define values of one or more RF parameters that affect the operability of the communication channel between NFC transmitter 410 and NFC receiver 450. TX CEN component 420 can provide one or more of TX CEN parameters 428 to TX component 422 to be sent to NFC receiver 450 in a communication establishment (CES) command, or to adjustment component 424 to establish and/or adjust the communication channel between NFC transmitter 410 and NFC receiver 450.

TX CEN parameters 428 can be stored in memory and retrieved by TX CEN component 420 or other components in NFC transmitter 410, such as TX component 422. TX CEN parameters 428 can include operation characteristics of NFC transmitter 410 and/or RF parameter preferences NFC transmitter 410 has for a communications channel.

For example, TX CEN parameters 428 can include a resonant frequency parameter that specifies one or more resonant frequencies for NFC transmitter 410. TX CEN parameters 428 can also include a field strength parameter that specifies the strength of the carrier field generated by NFC transmitter 410. In an aspect, TX CEN parameters 428 can also include a power-level negotiation preference parameter that can specify, for example on a scale of 0 to 10, the maximum power level of signals sent by NFC transmitter 410 or NFC receiver 450.

In an aspect, TX CEN parameters 428 can also include a geographic location parameter that indicates geographic location information, if known, in which NFC transmitter 410 is located. In some aspects, the geographic location information is a defined geographic location, such as a public transportation station (e.g., a subway stop) or an intersection. In some aspects, the geographic location information is a geographic region or country. In some aspects, the geographic location information may be coordinates, such as latitude and longitude coordinates (e.g., global positioning system [GPS] coordinates). In some aspects, certain performance settings can be specific to a geographic location (e.g., use of RF Type F technology in Asian regions) and adjustment component 424 can modify characteristics of the communication channel if the geographic location is known. In an aspect, NFC receiver 450 can use the geographic location parameter to determine the location of the NFC transmitter 410.

In an aspect, the geographic location parameter can be an identifier based on geographic location in lieu of geographic location information. For example, the geographic location parameter can store information for the specific NFC transmitter 410, such as a device identification (device ID) that the NFC receiver 450 can use to determine the location of NFC transmitter 410.

In an aspect, the geographic location parameter can include an operation setting that is based on the geographic location of the NFC transmitter 410. For example, TX CEN parameters 428 can include an operation setting, such as RF technology type (e.g., Type F), based on the location of NFC transmitter 410. In such instances, TX CEN parameters 428 can include a geographic location parameter that includes the operation setting in lieu of a specified location.

In an aspect, TX CEN parameters 428 can also include a load modulation type preference parameter that specifies whether NFC transmitter 410 prefers, for example, passive or active load modulation. As discussed above, in an aspect, other parameters, such as the load modulation type parameter included in RX CEN parameter 268 can override the preference for NFC transmitter 410.

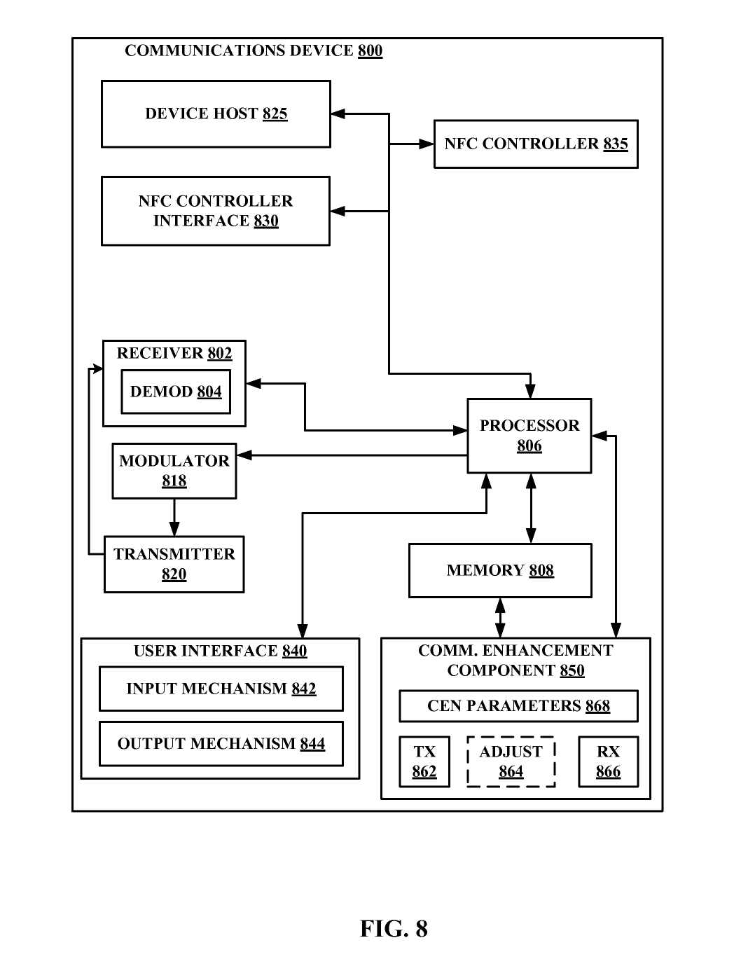

In some aspects, NFC receiver 450 can include an NFC controller 835 (see FIG. 8), which can include receiver (RX) communication enhancement (CEN) component 460 that can be configured to facilitate NFC operation of NFC receiver 450. As will be discussed in greater detail below, in some implementations, NFC RX CEN component 460 can be configured to send one or more of its RC CEN parameters 468 in a response to a received command from NFC transmitter 410.

RX CEN component 460 can include a TX component 462 for sending signals/messaging to NFC transmitter 410, a RX component 466 for receiving signals/messages from NFC transmitter 410, and one or more TX CEN parameters 468 that define preferences, limits, or settings related to establishing or maintaining a communication channel with NFC transmitter 410. RX CEN component 460 can be configured to receive a message (e.g., a CES command) from NFC transmitter 410 and provide one or more RX CEN parameters 468 in a message (e.g., a CES response) for NFC transmitter 410 to establish and adjust a communications channel between NFC transmitter 410 and NFC receiver 450.

More specifically, for example, TX component 462 can be configured to send and/or receive one or more messages via antenna 470 to/from NFC transmitter 410. In an aspect, for instance, TX component 462 can retrieve one or more of RX CEN parameters 468 and include them in a message (e.g., a CES response) and send the message to NFC transmitter 410. RX component 466 can be configured to receive one or more messages via antenna 470 from NFC transmitter 410. In an aspect, RX component 466 can receive a message (e.g., a CES command) from NFC transmitter 410.

Further, for example, receiver communication enhancement (RX CEN) parameters 468 can be configured to store one or more RF parameters that affect the operability of the communication channel between NFC transmitter 410 and NFC receiver 450. RX CEN component 460 can provide one or more of RX CEN parameters 468 to TX component 462 to be sent to NFC transmitter 410 in a message, such as a CES response or a subsequent message, for NFC transmitter 410 to establish and/or adjust the communication channel.

RX CEN parameters 468 can be stored in memory and retrieved by RX CEN component 460 or other components in NFC receiver 450, such as TX component 462. RX CEN parameters 468 can include values of operational characteristics of NFC receiver 450 for a communications channel. For example, RX CEN parameters 468 can include a resonant frequency parameter that specifies one or more resonant frequencies for NFC receiver 450. In an aspect, RX CEN parameters 468 can also include a power-level negotiation parameter that can specify, for example on a scale of 0 to 10, the maximum power level of signals that can be handled by NFC receiver 450.

In an aspect, RX CEN parameters 468 can also include a geographic location parameter that indicates geographic location information, if known, in which NFC receiver 450 is located. In some aspects, the geographic location information is a defined geographic location, such as a public transportation station (e.g., a subway stop) or an intersection. In some aspects, the geographic location information is a geographic region or country. In some aspects, the geographic location information may be coordinates, such as latitude and longitude coordinates (e.g., global positioning system [GPS] coordinates). In some aspects, certain performance settings can be specific to a geographic location (e.g., use of RF Type F technology in Asian regions) and adjustment component 424 of NFC transmitter 410 can modify characteristics of the communication channel if the geographic location is known. In an aspect, NFC receiver 450 can use the geographic location parameter to determine the location of the NFC transmitter 410.

In an aspect, the geographic location parameter can be an identifier based on geographic location in lieu of geographic location information. For example, the geographic location parameter can store information for the specific NFC receiver 450, such as a device identification (device ID) that the NFC transmitter 410 can use to determine the location of NFC receiver 450.

In an aspect, the geographic location parameter can include an operation setting that is based on the geographic location of the NFC receiver 450. For example, RX CEN parameters 468 can include an operation setting, such as RF technology type (e.g., Type F), based on the location of NFC transmitter 410. In such instances, RX CEN parameters 468 can include a geographic location parameter that includes the operation setting in lieu of a specified location.

In an aspect, RX CEN parameters 468 can also include a load modulation type parameter that specifies whether NFC receiver 450 operates, for example, using passive or active load modulation.

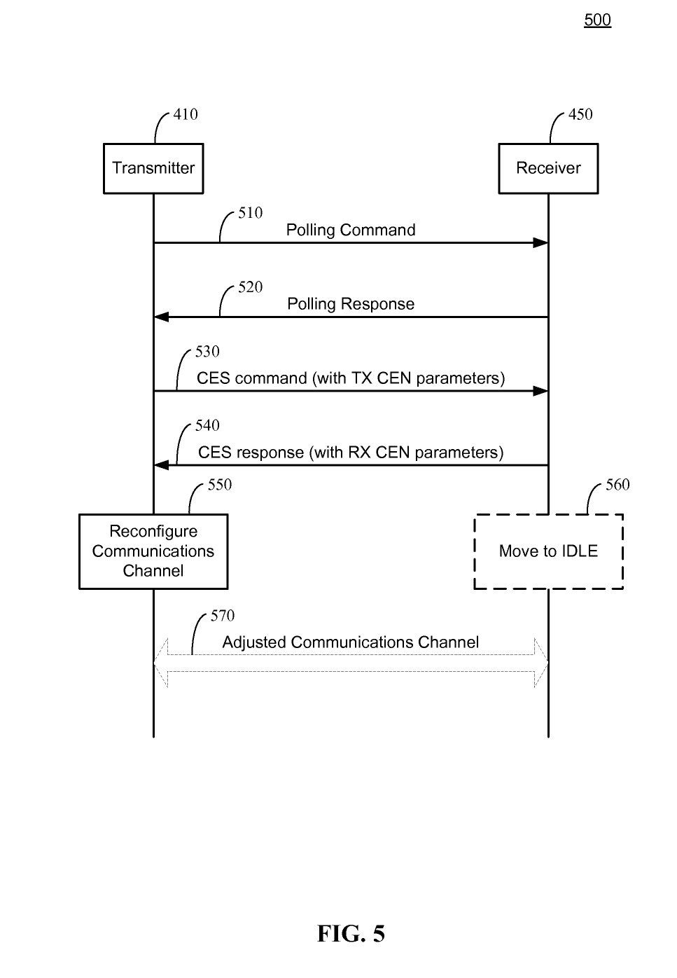

Referring to FIG. 5, diagram 500 is a signaling diagram describing transfers of message between devices and device components in accordance with an aspect of the present disclosure. For example, diagram 500 illustrates messages sent between NFC transmitter 410 and NFC receiver 450 based on the specific processes and mechanisms configured in TX CEN components 420 and RX CEN component 460, as described herein.

Initially, for instance in an optional aspect, NFC receiver 450 can receive a polling command 510 from NFC transmitter 410. NFC receiver 450 can respond by sending a polling response 520 to NFC transmitter 410.

Upon reception of a polling response, NFC transmitter 410 can send a communications establishment (CES) command 530 to NFC receiver 450. CES command 530 can be a customized or proprietary message that includes one or more parameters used by NFC transmitter 410 when establishing a communications channel. For example, but not limited hereto, CES command 530 can be a 7-byte packet that includes, in addition to an identification byte and an error detection byte, 5 bytes that include values for 5 parameters stored in TX CEN component 420. For example, CES command 530 can include bytes that represent a value of one or more of: a resonant frequency parameter, a field strength parameter, a maximum power control step parameter, a geographic location parameter, and a load modulation type preference parameter.

In an aspect, NFC receiver 450 can send a communications establishment (CES) response 540 to NFC transmitter 410. For instance, when NFC receiver 450 is a receiver capable of recognizing CES command 530, NFC receiver 450 can send a CES response 540 that includes one or more RX CEN parameters 468 stored in NFC receiver 450. CES response 540 can be a customized or proprietary message that includes one or more RX CEN parameters 468 used by NFC receiver 450 when establishing and/or adjusting a communications channel. For example, but not limited hereto, CES response 540 can be a 7-byte packet that includes, in addition to an identification byte, a reserved byte, and an error detection byte, 5 bytes that include values for 4 parameters stored in RX CEN component 460. For example, CES response 540 can include bytes that represent a value of one or more of: a resonant frequency parameter, a maximum power control step parameter, a geographic location parameter, and a load modulation type parameter.

At block 550, NFC transmitter 410 can adjust the communications channel. In an aspect, NFC transmitter 410 can establish and/or adjust the communications channel using one or more of TX CEN parameters 428 from NFC transmitter 410 and/or RX CEN parameters 468 from NFC receiver 450. In some aspects, NFC transmitter 410 can adjust the communication channel based on subsequent messages from NFC receiver 450 that include updated RX CEN parameters 468.

At block 560, NFC receiver 450 can optionally transition to an idle state after sending CES response 540. In some aspects, for instance, CES command 530 can act in a similar manner to a SLP_REQ command and cause NFC receiver 450 to respond to reception of command 530 by moving to an IDLE state after sending CES response 540.

Once NFC transmitter 410 adjusts the communications channel at block 550, NFC transmitter 410 and NFC receiver 450 can use the adjusted communications channel 570, which may result in improved communications. In some aspects, NFC transmitter 410 can further adjust the communication channel based on subsequent messages from NFC receiver 450 that include updated RX CEN parameters 468. For example, if the relative orientations of NFC transmitter 410 to NFC receiver 450 results in a change in the carrier field or distance 112, NFC transmitter 410 can further adjust communications channel 570. In another example, NFC receiver 450 can send additional packets that include additional parameters, which NFC transmitter 410 can use to further adjust communications channel 570. NFC transmitter 410 and NFC receiver 450 can use the further-adjusted communications channel 570, which may result in further improved communications.

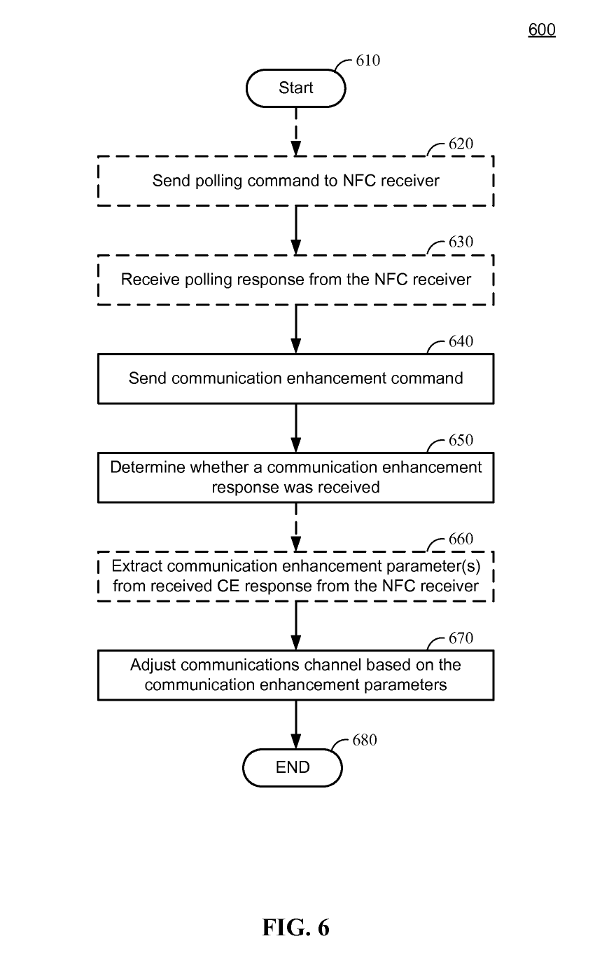

FIG. 6 is a flowchart of an aspect of a method 600 the present disclosure that may be performed by NFC transmitter 410, for example, when establishing a communications channel with NFC receiver 450.

At block 610, method 600 starts and at optional block 620, NFC transmitter 410 can optionally send a polling command to NFC receiver 450. In some aspects, NFC transmitter 410 can cycle through polling commands of different RF technologies (e.g., NFC-A, NFC-B, etc.). For example, NFC transmitter 410 can, at block 620, send a polling command 510 to NFC receiver 450. At optional block 630, NFC transmitter 410 can optionally receive a polling response from NFC receiver 405. For example, NFC transmitter 410 can, at block 630, receive polling response 520 from NFC receiver 450.

At block 640, NFC transmitter 410 can send a communication establishment (CES) message. In an aspect, for example, NFC transmitter 410 can send a message that includes one or more RF parameters that NFC transmitter 410 prefers to use when establishing a communications channel. For example, TX component 422 of NFC transmitter 410 can send CES command 530 including TX CEN parameters 428 to NFC receiver 450.

At block 650, NFC transmitter 410 can determine whether a CES response message was received. In an aspect, for example, RX component 426 of NFC transmitter 410 can determine whether it received a message from NFC receiver 450. For example, NFC transmitter 410 can receive CES response 540 from NFC receiver 450. CES response 540 can include one or more RF parameters (e.g., RX CEN parameters 468) under which NFC receiver 450 operates when using a communications channel. RX component 426 of NFC transmitter 410 can determine whether NFC transmitter 410 received CES response 540.

At block 660, NFC transmitter 410 can optionally extract parameters from the received message that was sent from NFC receiver 450. In an aspect, for example, when NFC transmitter 410 determines at block 650 that a CES response was received, it can extract RF parameters that were included in the received message. For example, when RX component 426 of NFC transmitter 410 determines that it received CES response 540, RX component 426 can extract one or more RX CEN parameters 468 from CES response 540.

At block 670, NFC transmitter 410 can adjust the communications channel based on the CEN parameters. In an aspect, for example, NFC transmitter 410 can establish and/or adjust a communications channel with NFC receiver 450 based on one or more RF parameters provided by NFC transmitter 410 and/or NFC receiver 450. For example, adjustment component 424 can configure one or more characteristics of a communications channel with NFC receiver 450 based on one or more TX CEN parameters 428 and/or RX CEN parameters 468. For example, adjustment component 424 can adjust the communications channel to enable active load modulation based on the value of the load modulation type parameter provided by NFC receiver 450 in RX CEN parameters 468. Once the adjusted communications channel 570 is configured, method 600 ends at block 680.

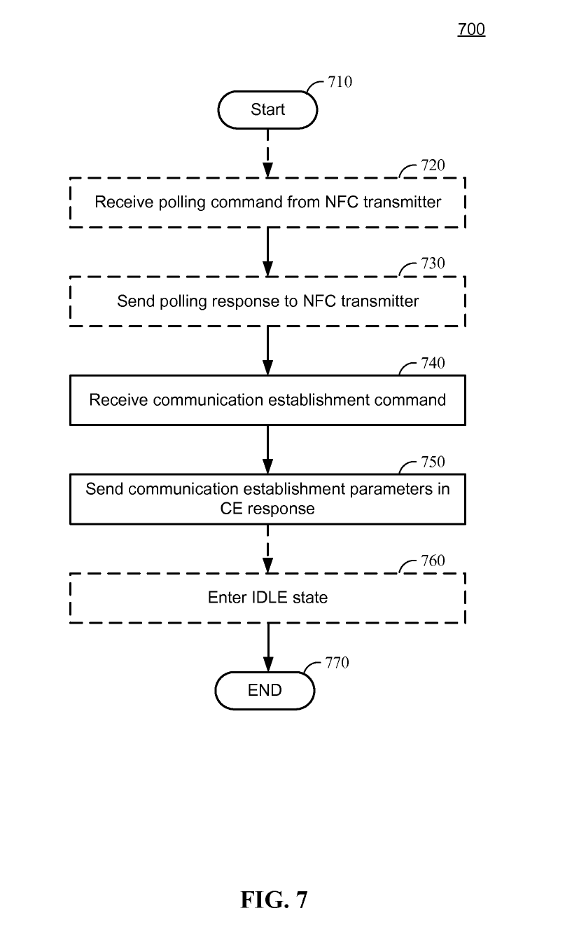

FIG. 7 is a flowchart of an aspect of a method 700 of the present disclosure that may be performed by NFC receiver 450, for example, when establishing a communications channel with NFC transmitter 410.

At optional block 710, method 700 starts and at optional block 720, NFC receiver 450 can receive a request message from NFC transmitter 410. In an aspect, for example, NFC receiver 450 can optionally receiver a request message, such as a polling command, from NFC transmitter 410 to commence communications. For example, NFC receiver 450 can receive a polling command 510 from NFC transmitter 410.

At optional block 730, NFC receiver 450 can optionally send a polling response to NFC transmitter 410. In an aspect, for example, NFC receiver 450 can send polling response 520 to NFC transmitter 410.

At block 740, NFC receiver 450 can receive a CES message. In an aspect, for example, NFC receiver 450 can receive a message that includes one or more RF parameters that NFC transmitter 410 prefers to use when establishing a communications channel. For example, RX component 466 of NFC receiver 450 can receive from NFC transmitter 410 a CES command 530 that includes one or more TX CEN parameters 468.

At block 750, NFC receiver 450 can send a CES response to NFC transmitter 410. In an aspect, for example, NFC receiver 450, if capable of parsing CES command 530, can send a CES response 540 back to NFC transmitter 410. In an aspect, CES response 540 can include one or more RF parameters (e.g., RX CEN parameters 468) under which NFC receiver 450 operates when using a communications channel. For example, TX component 462 of NFC receiver 450 can retrieve one or more RX CEN parameters 468 and include them in CES response 540.

At block 760, NFC receiver 450 can optionally enter an IDLE state. In some aspects, for example, the message received from NFC transmitter 410 can include a sleep request message. For example, CES command 530 can act in a similar manner to a SLP_REQ command. In such instances, NFC receiver 450 can respond to reception of command 530 by, at block 760, optionally moving to an IDLE state. Once NFC receiver 450 optionally enters into an IDLE state, method 700 ends at block 770.

FIG. 8 illustrates an example architecture of communications device 800. Communications device 800 can be the same as or include, for example, one of NFC transmitter 104, 302, 410, etc., NFC receiver 108, 304, 450, etc., and may thus include components thereof and/or perform the associated functions described above. In particular, communications device 800 may include CEN component 850, including, for example, TX component 862, RX component 866, adjustment component 864, and/or CEN parameters 868.

In an aspect, for example, where communication device is specially configured to act as an NFC transmitter, CEN component 850 may be the same as or similar to TX CEN component 420, TX component 862 may be the same as or similar to TX component 422, RX component 866 may be the same as or similar to RX component 426, adjustment component 864 may be the same as or similar to adjustment component 424, and CEN parameters 868 may be the same as or similar to TX CEN parameters 428.

In another aspect, for example, where communication device is specially configured to act as an NFC receiver, CEN component 850 may be the same as or similar to RX CEN component 460, TX component 862 may be the same as or similar to TX component 462, RX component 866 may be the same as or similar to RX component 466, adjustment component 864 may be omitted, and CEN parameters 868 may be the same as or similar to RX CEN parameters 468.

As depicted in FIG. 8, communications device 800 includes receiver 802 that receives a signal from, for instance, a receive antenna, performs typical actions on (e.g., filters, amplifies, down-converts, etc.) the received signal, and digitizes the conditioned signal to obtain samples. Receiver 802 can include a demodulator 804 that can demodulate received symbols and provide them to processor 806 for channel estimation.

Processor 806 can be a processor dedicated to analyzing information received by receiver 802 and/or generating information for transmission by transmitter 820. In an aspect, processor 806 can be a processor that controls one or more components of communications device 800. In another aspect, processor 806 can be a processor that both analyzes information received by receiver 802, generates information for transmitter 820, and controls one or more components of communications device 800. Further, signals may be prepared for transmission by transmitter 820 through modulator 818, which can modulate the signals processed by processor 806. In some aspects, processor 806 may include one or more processor hardware or firmware components for performing the aspects described herein, such as CEN component 850, including, for example, TX component 862, RX component 866, adjustment component 864, and/or CEN parameters 868.

Communications device 800 can additionally include memory 808 that is operatively coupled to processor 806. Memory 808 can store, for example: data to be transmitted, received data, information related to available channels, Transmission Control Protocol (TCP) flows, data associated with analyzed signals and/or interference strength, information related to an assigned channel, power, rate, or the like, and any other suitable information for estimating a channel and communicating via the channel. In some aspects, memory 808 can store computer executable code, e.g., executable by processor 806, wherein the code defines CEN component 850, including, for example, TX component 862, RX component 866, optional adjustment component 864, and/or CEN parameters 868.

It will be appreciated that a data store (e.g., memory 808) described herein can be either volatile memory or nonvolatile memory, or can include both volatile and nonvolatile memory. By way of illustration, and not limitation, nonvolatile memory can include: read-only memory (ROM), programmable ROM (PROM), electrically-programmable ROM (EPROM), electrically-erasable PROM (EEPROM), or flash memory. Volatile memory can include random-access memory (RAM), which acts as external cache memory. By way of illustration and not limitation, RAM is available in many forms, such as: synchronous RAM (SRAM), dynamic RAM (DRAM), synchronous DRAM (SDRAM), double data-rate SDRAM (DDR SDRAM), enhanced SDRAM (ESDRAM), Synchlink DRAM (SLDRAM), and direct Rambus RAM (DRRAM). Memory 808 of the subject systems and methods can comprise, without being limited to, these and any other suitable types of memory. For example, memory 808 can include instructions for performing the functions of the various components described herein.

Communications device 800 can include NFC controller interface (NCI) 830. In an aspect, NCI 830 can be configured to enable communications between NFC controller 835 and device host 825. Additionally, communications device 800 can include user interface (UI) 840. UI 840 can include input mechanisms 842 for generating inputs into communications device 800, and output mechanism 844 for generating information for consumption by the user of the communications device 800. For example, input mechanism 842 can include a mechanism, such as: a key or keyboard, a mouse, a touch-screen display, an audio speaker, a haptic feedback mechanism, etc. In the illustrated aspects, the output mechanism 844 can include a display configured to present media content that is in image or video format or an audio speaker to present media that is in an audio format.

As used in this application, the terms “component”, “module”, “system”, and the like, are intended to include a computer-related entity, such as, but not limited to: hardware, firmware, a combination of hardware and software, software, or software in execution. For example, a component may be, but is not limited to being: a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer-readable media having various data structures stored thereon. The components may communicate by way of local and/or remote processes, such as in accordance with a signal having one or more data packets, such as data from one component interacting with another component in a local system, distributed system, and/or across a network, such as the Internet with other systems by way of the signal.

Furthermore, various aspects are described herein in connection with a terminal, which can be a wired terminal or a wireless terminal. A terminal can also be called: a system, device, subscriber unit, subscriber station, mobile station, mobile, mobile device, remote station, mobile equipment (ME), remote terminal, access terminal, user terminal, terminal, communication device, user agent, user device, or user equipment (UE). A wireless terminal may be: a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as: an access point, a Node B, or some other terminology.

Moreover, the term “or” is intended to mean an inclusive “or”, rather than an exclusive “or” (XOR). That is, unless specified otherwise, or clear from context, the phrase, “X employs A or B” is intended to mean any of the natural inclusive permutations. That is, the phrase, “X employs A and B” is satisfied by any of the following instances: X employs, A; X employs B; or X employs both A and B. In addition, the articles “a” and “an”, as used in this application and the appended claims, should generally be construed to mean “one or more”, unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology, such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology, such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH, near-field communications (NFC-A, NFC-B, NFC,-f, etc.), and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with: a general purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules configured to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

1. A method of wireless near-field communications (NFC), comprising:
sending, by an NFC transmitter, a communication establishment (CES) command, wherein the CES command includes at least one transmitter communication enhancement (TX CEN) parameter comprising an operation setting based on a geographic location of the NFC transmitter;
determining whether a CES response was received from an NFC receiver; and
adjusting a communications channel based on at least one receiver (RX) CEN parameter included in the CES response based on the at least one TX CEN parameter.

2. The method of claim 1, wherein the at least one TX CEN parameter or the at least one RX CEN parameter comprises at least of a strength of a carrier field of the NFC transmitter.

3. The method of claim 1, wherein the at least one TX CEN parameter or the at least one RX CEN parameter comprises at least of a load modulation preference of the NFC transmitter or a load modulation type of the NFC receiver.

4. The method of claim 1, further comprising:
receiving, from the NFC receiver, a subsequent CES response, wherein the CES response includes the at least one RX CEN parameter comprising an operation setting based on a geographic location of the NFC receiver; and
adjusting the communications channel based on the at least one RX CEN parameter included in the subsequent CES response.

5. The method of claim 1, wherein the CES command further comprises:
an implicit or explicit sleep request for the NFC receiver to cause the NFC receiver to change to a sleep state after sending the CES response.

6. The method of claim 1, further comprising:
updating at least one TX CEN parameter after the communications channel is established, wherein the updating is based on a change in the communications channel; and
adjusting the communications channel based on the at least one updated TX CEN parameter.

7. A method of wireless near-field communication (NFC), comprising:
receiving, by an NFC receiver, a communication establishment (CES) command from an NFC transmitter, wherein the CES command includes at least one transmitter communication enhancement (TX CEN) parameter; and
sending a CES response, wherein the CES response includes at least one receiver (RX) CEN parameter comprising an operation setting based on a geographic location of the NFC receiver,
wherein the establishment of a communications channel is adjusted by the NFC transmitter based on the at least one RX CEN parameter included in the CES response.

8. The method of claim 7, wherein the at least one TX CEN parameter or the at least one RX CEN parameter comprises at least one parameter from the group consisting of:
a strength of a carrier field of the NFC transmitter; and
a load modulation preference of the NFC transmitter or a load modulation preference of the NFC receiver.

9. The method of claim 7, further comprising:
changing to an idle state after sending the CES response, wherein the CES command includes an implicit or explicit sleep request to change to the idle state.

10. The method of claim 7, further comprising:
updating the at least one RX CEN parameter after the communications channel is established, wherein the updating is based on a change in the communications channel.

11. The method of claim 10, further comprising:
sending a subsequent CES response to the NFC transmitter, wherein the CES response includes the at least one updated RX CEN parameter.

12. An apparatus for wireless near-field communications (NFC), comprising:
an NFC transmitter configured to:
send a communication establishment (CES) command, wherein the CES command includes at least one transmitter communication enhancement (TX CEN) parameter comprising an operation setting based on a geographic location of the NFC transmitter;
determine whether a CES response was received from an NFC receiver; and
adjust a communications channel based on at least one receiver (RX) CEN parameter included in the CES response based on the at least one TX CEN parameter.

13. The apparatus of claim 12, wherein the at least one TX CEN parameter or the at least one RX CEN parameter comprises at least of a strength of a carrier field of the NFC transmitter.

14. The apparatus of claim 12, wherein the at least one TX CEN parameter or the at least one RX CEN parameter comprises at least of a load modulation preference of the NFC transmitter or a load modulation type of the NFC receiver.

15. The apparatus of claim 12, wherein the NFC transmitter is further configured to:
receive a subsequent CES response from the NFC receiver, wherein the CES response includes the at least one RX CEN parameter comprising an operation setting based on a geographic location of the NFC receiver; and
adjust the communications channel based on the at least one RX CEN parameter included in the subsequent CES response.

16. The apparatus of claim 15, wherein the CES command further comprises:
an implicit or explicit sleep request for the NFC receiver to cause the NFC receiver to change to a sleep state after sending the CES response.

17. The apparatus of claim 12, wherein the NFC transmitter is further configured to:
update at least one TX CEN parameter after the communications channel is established, wherein the updating is based on a change in the communications channel; and
adjust the communications channel based on the at least one updated TX CEN parameter.

18. An apparatus for wireless near-field communication (NFC), comprising:
a NFC receiver configured to:
receive a communication establishment (CES) command from an NFC transmitter, wherein the CES command includes at least one transmitter communication enhancement (TX CEN) parameter; and
send a CES response, wherein the CES response includes at least one receiver (RX) CEN parameter comprising an operation setting based on a geographic location of the NFC receiver,
wherein the establishment of a communications channel is adjusted by the NFC transmitter based on the at least one RX CEN parameter included in the CES response.

19. The apparatus of claim 18, wherein the at least one TX CEN parameter or the at least one RX CEN parameter comprises at least one of a strength of a carrier field of the NFC transmitter.

20. The apparatus of claim 18, wherein the at least one TX CEN parameter or the at least one RX CEN parameter comprises at least one of a load modulation preference of the NFC transmitter or a load modulation type of the NFC receiver.

21. The apparatus of claim 18, wherein the NFC receiver is further configured to:
change to an idle state after sending the CES response, wherein the CES command includes an implicit or explicit sleep request to change to the idle state.

22. The apparatus of claim 18, wherein the NFC receiver is further configured to:
update the at least one RX CEN parameter after the communications channel is established, wherein the updating is based on a change in the communications channel.

23. The apparatus of claim 22, wherein the NFC receiver is further configured to:
send a subsequent CES response to the NFC transmitter, wherein the CES response includes the at least one updated RX CEN parameter.
